(19) United States
(12) Patent Application Publication
(10) Pub. No.: US 2024/0144076 A1
(43) Pub. Date: May 2, 2024

(54) SYSTEMS AND METHODS FOR CENTRALIZED DATA GOVERNANCE WITHIN DISTRIBUTED COMPONENT COMPUTING ENVIRONMENTS

(71) Applicant: BANK OF AMERICA CORPORATION, Charlotte, NC (US)

(72) Inventors: Pratap Dande, Saint Johns, FL (US); Tileshia Brenda Alford, Charlotte, NC (US); Erik Dahl, Newark, DE (US); Vishwanath Prasad Karra, McKinney, TX (US); Steven Allan Reich, Manalapan, NJ (US); Rahul Yaksh, Austin, TX (US)

(73) Assignee: BANK OF AMERICA CORPORATION, Charlotte, NC (US)

(21) Appl. No.: 17/976,546

(22) Filed: Oct. 28, 2022

(51) Int. Cl. G06N 20/00

(52) U.S. Cl. CPC G06N 20/00

(57) ABSTRACT

Systems, methods, and computer program products are provided herein for centralized data governance within distributed component computing environments. An example method includes receiving first component metadata associated with one or more operating parameters of the first distributed computing component and second component metadata associated with one or more operating parameters of the second distributed computing component. The method includes determining, via a machine learning (ML) subsystem, a centralized governance dataset based upon the first component metadata and the second component metadata. The method further includes generating a representation of the centralized governance dataset that is accessible by one or more of the first distributed computing component or the second distributed computing component.

### TECHNOLOGICAL FIELD

Example embodiments of the present disclosure relate generally to distributed component computing environments and, more particularly, to systems and methods for machine learning based centralized data governance within these environments.

### BACKGROUND

Computing environments, networks, systems, etc. may include various computing devices that are connected together to perform common and/or distributed processes. For example, distributed computing environments may include distributed computing components that are associated with distinct operational capabilities, requirements, characteristics, and/or the like. Applicant has identified a number of deficiencies and problems associated with conventional data governance in distributed component computing environments. Through applied effort, ingenuity, and innovation, many of these identified problems have been solved by developing solutions that are included in embodiments of the present disclosure, many examples of which are described in detail herein.

### BRIEF SUMMARY

Apparatuses, systems, methods, and computer program products are provided for centralized data governance within distributed component computing environments. In one aspect, a system for centralized data governance within distributed component computing environments is provided. The system may include at least one non-transitory storage device and at least one processor coupled to the at least one non-transitory storage device. The at least one processor may be configured to receive, from a first distributed computing component, first component metadata associated with one or more operating parameters of the first distributed computing component. The processor may further be configured to receive, from a second distributed computing component, second component metadata associated with one or more operating parameters of the second distributed computing component.

The processor may be configured to determine, via a machine learning (ML) subsystem, a centralized governance dataset based upon the first component metadata and the second component metadata. The processor may further be configured to generate a representation of the centralized governance dataset, wherein the representation is accessible by one or more of the first distributed computing component or the second distributed computing component.

In some embodiments, in determining the centralized governance dataset, the processor may be further configured to deploy, via the ML subsystem, a trained ML model on the first component metadata and the second component metadata.

In some further embodiments, prior to deployment of the trained ML model, the processor may be further configured to generate a feature set using the first component metadata and the second component metadata and train, using the ML subsystem, the trained ML model using the feature set to generate the trained ML model.

In some embodiments, in determining the centralized governance dataset, the processor may be further configured to deploy, via the ML subsystem, a first trained ML model on the first component metadata and deploy, via the ML subsystem, a second trained ML model on the second component metadata.

In some further embodiments, prior to deployment of the first trained ML model, the processor may be further configured to generate a first feature set using the first component metadata and train, using the ML subsystem, the first trained ML model using the first feature set to generate the first trained ML model.

In some further embodiments, prior to deployment of the second trained ML model, the processor is further configured to generate a second feature set using the second component metadata and train, using the ML subsystem, the second trained ML model using the second feature set to generate the second trained ML model.

In some embodiments, the first component metadata may define a first component format, and the second component metadata may define a second component format.

In some further embodiments, in determining the centralized governance dataset, the processor may be further configured to reconcile the first component format and the second component format to a centralized governance format.

In some embodiments, the processor may be further configured to modify one or more of the first component format or the second component format responsive to the centralized governance dataset.

In some embodiments, the processor may be further configured to modify one of more operations of the first distributed computing component and/or one or more operations the second distributed computing component responsive to the centralized governance dataset.

In one aspect, a computer program product for centralized data governance within distributed component computing environments is provided. The computer program product may include a non-transitory computer-readable medium comprising code causing an apparatus to receive, from a first distributed computing component, first component metadata associated with one or more operating parameters of the first distributed computing component and receive, from a second distributed computing component, second component metadata associated with one or more operating parameters of the second distributed computing component. The apparatus may further determine, via a machine learning (ML) subsystem, a centralized governance dataset based upon the first component metadata and the second component metadata and generate a representation of the centralized governance dataset, wherein the representation is accessible by one or more of the first distributed computing component or the second distributed computing component.

In one aspect, a method for centralized data governance within distributed component computing environments is provided. The method may include receiving, from a first distributed computing component, first component metadata associated with one or more operating parameters of the first distributed computing component and receiving, from a second distributed computing component, second component metadata associated with one or more operating parameters of the second distributed computing component. The method may further include determining, via a machine learning (ML) subsystem, a centralized governance dataset based upon the first component metadata and the second component metadata and generating a representation of the centralized governance dataset, wherein the representation is accessible by one or more of the first distributed computing component or the second distributed computing component.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below. The features, functions, and advantages that are described herein may be achieved independently in various embodiments of the present disclosure or may be combined with yet other embodiments.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an example distributed computing environment for centralized data governance in accordance with one or more embodiments of the present disclosure;

FIG. 2 illustrates a method for centralized data governance within distributed component computing environments in accordance with one or more embodiments of the present disclosure; and

FIG. 3 illustrates machine learning based techniques for centralized data governance within distributed component computing environments in accordance with one or more embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships, and/or potential future relationships with an entity. In some embodiments, the user may be an employee (e.g., an associate, a project manager, an IT specialist, a manager, an administrator, an internal operations analyst, or the like) of the entity or enterprises affiliated with the entity. In some embodiments, the user may be a customer (e.g., individual, business, etc.) that transacts with the entity or enterprises associated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users. In some embodiments, the systems described herein may generate a representation of one or more datasets that may, for example, include a visual representation of such a dataset. As such, in such embodiments, the representation may refer to a user interface that is rendered for viewing by an associated user of the system and may further include one or more actionable inputs configured to receive an input from the user. For example, the representations described herein may refer to user interfaces that include actionable reports, metrics, data analytics, etc. generated in determination of the centralized governance dataset described herein.

As used herein, an “engine,” “module” and/or “subsystem” may refer to core elements of an application, or part of an application that serves as a foundation for a larger piece of software and drives the functionality of the software. In some embodiments, an engine or module may be self-contained, but externally-controllable code that encapsulates powerful logic designed to perform or execute a specific type of function. In one aspect, an engine or module may be underlying source code that establishes file hierarchy, input and output methods, and how a specific part of an application interacts or communicates with other software and/or hardware. The specific components of an engine or module may vary based on the needs of the specific application as part of the larger piece of software. In some embodiments, an engine or module may be configured to retrieve resources created in other applications, which may then be ported into the engine for use during specific operational aspects of the engine. An engine or module may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” “communicably coupled” and/or the like as used herein, means that the components may be formed integrally with each other, or may be formed separately and coupled together. Furthermore, the components may be formed directly to each other, or to each other with one or more components located between the components that are operatively coupled together. Furthermore, the components may be detachable from each other, or they may permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As described above, computing environments, networks, systems, etc. may include various computing devices that are connected together to perform common and/or distributed processes. In some instances, distributed computing environments may include distributed computing components that are associated with distinct operational capabilities, requirements, characteristics, and/or the like. Each of these distributed components may, for example, be associated with differing data formats, operating times, sampling rates, regulation requirements, timing requirements, data collection/retention policies, data access credentials, and/or the like. These different operating parameters, characteristics, etc. among the different distributed computing components or devices often results in an inability for centralized data analysis to occur. For example, in some instances, a centralized system may lack a singular dataset against which other distributed datasets or collections of metadata may be validated.

Accordingly, the embodiments of the present disclosure may leverage machine learning techniques to analyze metadata from distributed computing components that are indicative or associated with operating parameters of these components. For example, the systems described herein may receive first and second component metadata from distributed computing components and determine, via a machine learning (ML) subsystem, a centralized governance based upon this metadata. This centralized governance dataset may be generated by deployment of machine learning models that are, for example, trained on metadata from multiple distributed computing components or based upon component-specific metadata and may be further presented to a user for review or manipulation. Furthermore, in some embodiments, the system may modify one or more operations of the distributed computing components in response to the generation of the centralized governance dataset so as to, for example, improve further iterations of the operations described herein. In doing so, the embodiments of the present disclosure iteratively standardize distinct distributed component operating parameters so as to reduce the storage and processing burdens associated with emerging distributed computing environments.

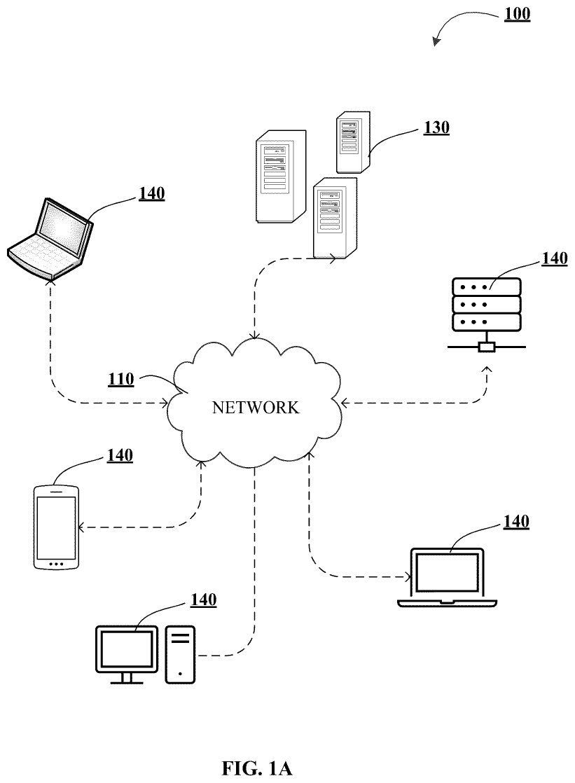

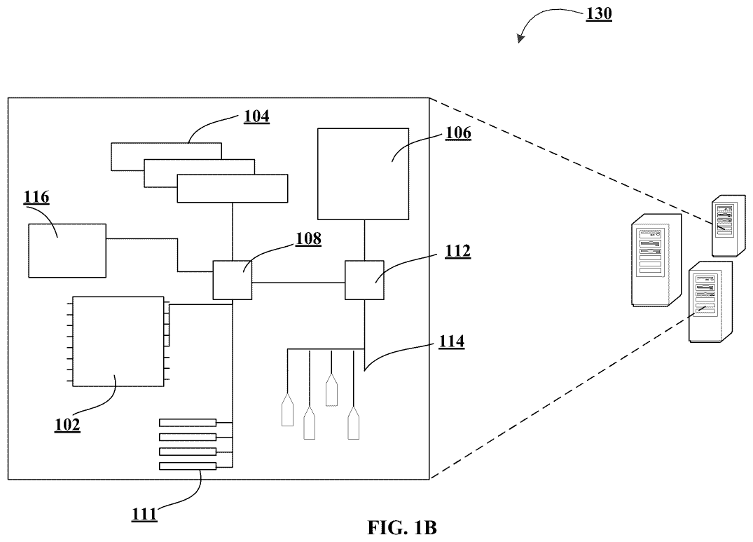

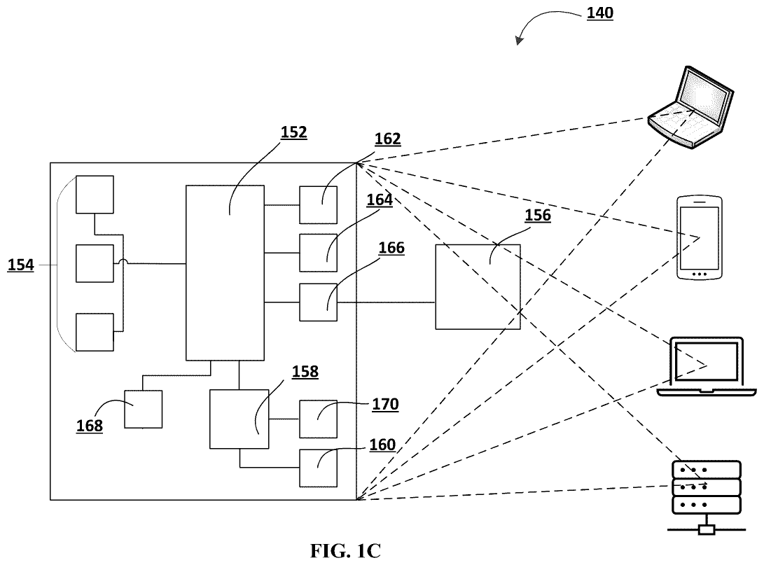

FIGS. 1A-1C illustrate technical components of an exemplary system for centralized data governance within distributed component computing environments 100, in accordance with one or more embodiments of the present disclosure. As shown in FIG. 1A, the distributed computing environment 100 contemplated herein may include a system 130, distributed computing components 140, and a network 110 over which the system 130 and distributed computing components 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, the same or similar to system 130, with each system providing portions of the necessary operations (e.g., as a server bank, a group of blade servers, or a multi-processor system).

In some embodiments, the system 130 and the distributed computing components 140 may define a client-server relationship in which the distributed computing components 140 are remote devices that request and receive service from a centralized server (e.g., the system 130). In some other embodiments, the system 130 and the distributed computing components 140 may have a peer-to-peer relationship in which the system 130 and the distributed computing components 140 have the same abilities to use the resources available on the network 110. As opposed to relying upon a central server (e.g., system 130) that acts as the shared drive, each device that is connected to the network 110 acts as the server for the files stored thereon.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The distributed computing components 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., an automated teller machine (ATM)), and/or edge devices such as routers, routing switches, integrated access devices (IAD), and/or the like. In some embodiments, the distributed computing components 140 may include at least a first distributed computing component that generates or is otherwise associated with first component metadata associated with one or more operating parameters of the first distributed computing component. The one or more operating parameters of the first distributed computing component may be any characteristics, parameters, etc. of the first distributed computing component including the data format, operating time, sampling rate, regulation requirements, timing requirement, data collection/retention policies, data access credentials, user interaction data, and/or the like for the first distributed computing component. Similarly, the distributed computing components 140 may include at least a second distributed computing component that generates or is otherwise associated with second component metadata associated with one or more operating parameters of the second distributed computing component. The one or more operating parameters of the second distributed computing component may be any characteristics, parameters, etc. of the second distributed computing component including the data format, operating time, sampling rate, regulation requirements, timing requirement, data collection/retention policies, data access credentials, user interaction data, and/or the like for the second distributed computing component. Although described herein with reference to a first and a second distributed computing component, the present disclosure contemplates that the environment 100 may include any number of distributed computing components collectively illustrated and referred to herein as distributed computing components 140.

The network 110 may be a distributed network that is spread over different networks. This provides a single data communication network that may be managed jointly or separately by each network. In addition to shared communication within the network, the distributed network may also support distributed processing. The network 110 may be a form of digital communication network, such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the embodiments of the present disclosure. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with one or more embodiments of the present disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems, such as a machine learning subsystem, to execute the portions of processes described herein. Each subsystem may be a self-contained component of a larger system (e.g., system 130) and capable of being configured to execute specialized processes as part of the larger system.

The processor 102 may process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 may be capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and/or to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the distributed computing components 140, in accordance with one or more embodiments of the present disclosure. As shown in FIG. 1C, the distributed computing components 140 includes a processor 152, memory 154, an input/output device such as a display 156, a communication interface 158, and a transceiver 160, among other components. The distributed computing components 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the distributed computing components 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the distributed computing components 140, such as control of user interfaces, applications run by distributed computing components 140, and wireless communication by distributed computing components 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user (e.g., an actionable notification or the like). The control interface 164 may receive commands from a user and convert them for submission to the processor 152. In addition, an external interface 168 may be provided in communication with processor 152, so as to enable near area communication of distributed computing components 140 with other devices. External interface 168 may provide, for example, for wired communication in some implementations, or for wireless communication in other implementations, and multiple interfaces may also be used.

The memory 154 stores information within the distributed computing components 140. The memory 154 may be implemented as one or more of a computer-readable medium or media, a volatile memory unit or units, or a non-volatile memory unit or units. Expansion memory may also be provided and connected to distributed computing components 140 through an expansion interface (not shown), which may include, for example, a SIMM (Single In Line Memory Module) card interface. Such expansion memory may provide extra storage space for distributed computing components 140 or may also store applications or other information therein. In some embodiments, expansion memory may include instructions to carry out or supplement the processes described above and may include secure information also. For example, expansion memory may be provided as a security module for distributed computing components 140 and may be programmed with instructions that permit secure use of distributed computing components 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the distributed computing components 140 to transmit and/or receive information or commands to and from the system 130 via the network 110. Any communication between the system 130 and the distributed computing components 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the distributed computing components 140 may provide the system 130 (or other client devices) permissioned access to the protected resources of the distributed computing components 140, which may include a GPS device, an image capturing component (e.g., camera), a microphone, and/or a speaker.

The distributed computing components 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to distributed computing components 140, which may be used as appropriate by applications running thereon, and in some embodiments, one or more applications operating on the system 130.

The distributed computing components 140 may also communicate audibly using audio codec 162, which may receive spoken information from a user and convert it to usable digital information. Audio codec 162 may likewise generate audible sound for a user, such as through a speaker, e.g., in a handset of distributed computing components 140. Such sound may include sound from voice telephone calls, may include recorded sound (e.g., voice messages, music files, etc.) and may also include sound generated by one or more applications operating on the distributed computing components 140, and in some embodiments, one or more applications operating on the system 130.

Various implementations of the distributed computing environment 100, including the system 130 and distributed computing components 140, and techniques described here may be realized in digital electronic circuitry, integrated circuitry, specially designed ASICs (application specific integrated circuits), computer hardware, firmware, software, and/or combinations thereof.

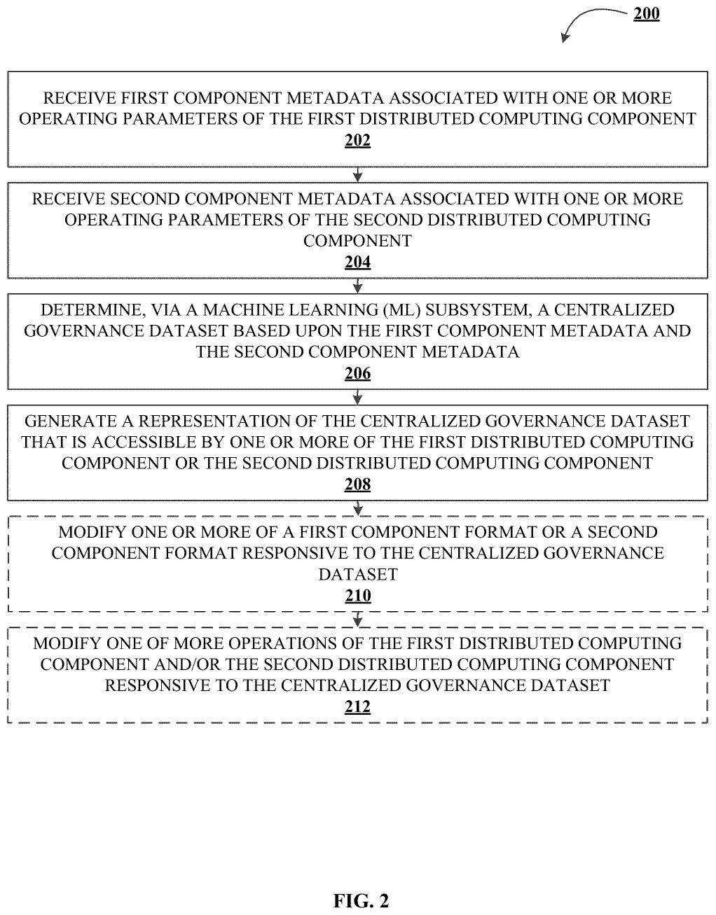

FIG. 2 illustrates a flowchart containing a series of operations for example centralized data governance within distributed component computing environments (e.g., method 200). The operations illustrated in FIG. 2 may, for example, be performed by, with the assistance of, and/or under the control of an apparatus (e.g., system 130, distributed computing components 140, etc.), as described above. In this regard, performance of the operations may invoke one or more of the components described above with reference to FIGS. 1A-1C (e.g., processor 102, processor 152, etc.).

As shown in operation 202, the system 130 may be configured to receive first component metadata associated with one or more operating parameters of the first distributed computing component. In some embodiments, the first component metadata may be received from the first distributed computing component. For example, the first computing component may iteratively generate first component metadata associated with operations of the first distributed computing component as part of performing its intended operations. As described above, the one or more operating parameters of the first distributed computing component may be any characteristics, parameters, etc. of the first distributed computing component including the data format, operating time, sampling rate, regulation requirements, timing requirement, data collection/retention policies, data access credentials, user interaction data, and/or the like for the first distributed computing component. The present disclosure contemplates that the first component metadata may refer to any characteristic of the first distributed computing component and the operations performed by the first distributed computing component without limitation. In some embodiments, the first component metadata may define a first component format that refers to the particular format, orientation, storage method, appearance, etc. of the first component metadata which may be unique for the first distributed computing component.

With continued reference to operation 202, the first component metadata may be received from the first distributed computing component via direct transmission to the system 130 or via one or more intermediary devices. In some instances, the first component metadata may be provided to the system 130 in response to a request for the first component metadata from the system 130. In other instances, the first distributed computing component may automatically (e.g., according to a determined sampling rate or the like) transmit the first component metadata to the system 130. In some instances, the receipt of the first component metadata may iteratively occur in response to iterative instructions from the system 130, such as to modify one or more operations of the first distributed computing component as described hereafter.

As shown in operation 204, the system 130 may be configured to receive second component metadata associated with one or more operating parameters of the second distributed computing component. In some embodiments, the second component metadata may be received from the second distributed computing component. For example, the second computing component may iteratively generate second component metadata associated with operations of the second distributed computing component as part of performing its intended operations. As described above, the one or more operating parameters of the second distributed computing component may be any characteristics, parameters, etc. of the second distributed computing component including the data format, operating time, sampling rate, regulation requirements, timing requirement, data collection/retention policies, data access credentials, user interaction data, and/or the like for the second distributed computing component. The present disclosure contemplates that the second component metadata may refer to any characteristic of the second distributed computing component and the operations performed by the second distributed computing component without limitation. In some embodiments, the second component metadata may define a second component format that refers to the particular format, orientation, storage method, appearance, etc. of the second component metadata which may be unique for the second distributed computing component. In such an embodiment, the first component format may be different from the second component format such that the system 130 may be required to perform reconciliation operations to standardize this data format as described hereafter.

With continued reference to operation 204, the second component metadata may be received from the second distributed computing component via direct transmission to the system 130 or via one or more intermediary devices. In some instances, the second component metadata may be provided to the system 130 in response to a request for the second component metadata from the system 130. In other instances, the second distributed computing component may automatically (e.g., according to a determined sampling rate or the like) transmit the second component metadata to the system 130. In some instances, the receipt of the second component metadata may iteratively occur in response to iterative instructions from the system 130, such as to modify one or more operations of the second distributed computing component as described hereafter. In some embodiments, the receipt of the second component metadata may occur responsive to the receipt of the first component metadata.

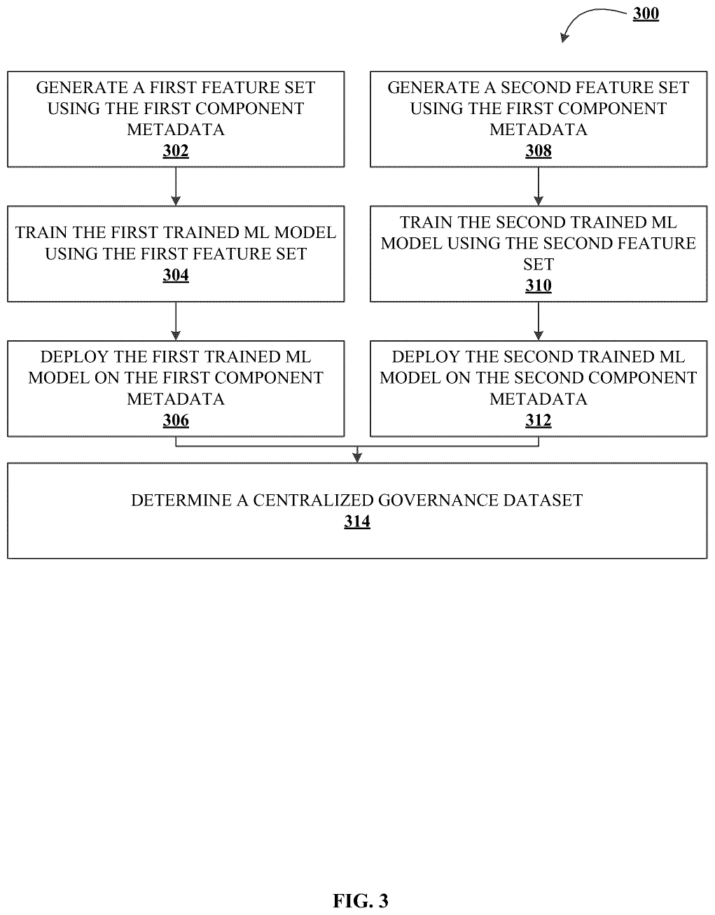

As shown in operation 206, the system 130 may be configured to determine, via a machine learning (ML) subsystem, a centralized governance dataset based upon the first component metadata and the second component metadata. As described above, the first distributed computing component and the second distributed computing component may be associated with distinct operating parameters and, therefore, at least partially generate distinct metadata associated with these operating parameters. As such, conventional systems fail to efficiently account for these distinct operating parameters and their associated impacts on data governance and analysis resulting increased computational and processing loads associated with distributed computing components. As described more fully hereinafter with reference to FIG. 3, the embodiments of the present disclosure may leverage machine learning and/or artificial intelligence techniques to determine a centralized governance dataset based upon the distinct component metadata associated with the example first and second distributed computing components.

By way of a non-limiting example, the system 130 may compare the first component metadata and the second component metadata (as well as component metadata from any number of distributed computing components) to determine one or more commonalties and one or more distinctions between the operating parameters of these components. For example, the system 130 may determine that the first component metadata fails to include a particular categorization of operating parameter that is present in the second component metadata. After iterative analysis of the metadata, via the machine learning models described hereinafter, the system 130 may determine a centralized governance dataset that serves as a singular representation of truth or valid data entries for the system 130. For example, in generating the centralized governance dataset, the system 130 may reconcile distinctions between the particular component formats used by the distributed computing components to form a centralized governance format that is standardized for access by the distributed computing components 140.

Thereafter, as shown in operation 208, the system 130 may generate a representation of the centralized governance dataset. This representation may be accessible by one or more of the first distributed computing component or the second distributed computing component as well as by other distributed computing components 140 of the example environment 100. In some embodiments, the representation at operation 208 may refer to a visual representation of user interface by which a user may interact with the centralized governance dataset. By way of an example, the representation (e.g., user interface) may allow a user to access, retrieve, etc. data associated with any number of distributed computing components and may further generate various reports regarding the underlying operations associated with the various distributed computing components. The present disclosure contemplates that the presentation of the centralized governance dataset may refer to the ability for a user to access any information of the centralized governance dataset based upon the intended application of the system 130.

In some embodiments, as shown in operation 210, the system 130 may modify one or more of the first component format or the second component format responsive to the centralized governance dataset. By way of continued example, the format associated with the component metadata of a particular distributed computing component may initially be distinct or at least partially unique relative to the format of other component metadata. In order to further improved subsequent operation of the methods described herein, the system 130 may generate instructions that modify the first component metadata and/or the second component metadata such that these data entries at least partially comply with a standardized data format (e.g., a centralized governance format). Such an instruction may, in some embodiments, cause modification to the operations of the respective first distributed computing component or the second distributed computing component in order to cause metadata to be generated that complies with this standardized format.

In some embodiments, as shown in operation 212, the system 130 may modify one of more operations of the first distributed computing component and/or one or more operations the second distributed computing component responsive to the centralized governance dataset. In addition to the format described above, the system 130 may, in determining the centralized governance dataset, identify various operation modifications that may improve the operations of the distributed computing components. For example, a particular operation that occurs on the second distributed computing component may not be performed by the first distributed computing component. In some instances, the system 130 may determine that it is advantageous for the first distributed computing component to perform this operation of the second distributed computing component. As such, the system 130 may modify operation of the first distributed computing component to include this operation.

FIG. 3 illustrates a flowchart containing a series of operations for machine learning based techniques for centralized data governance within distributed component computing environments (e.g., method 300). The operations illustrated in FIG. 3 may, for example, be performed by, with the assistance of, and/or under the control of an apparatus (e.g., system 130, distributed computing components 140, etc.), as described above. In this regard, performance of the operations may invoke one or more of the components described above with reference to FIGS. 1A-1C (e.g., processor 102, processor 152, etc.).

As shown in operations 302, 304 the system 130 may generate a first feature set using the first component metadata and train the first trained ML model using the first feature set. By way of example, a first ML model may ingest or otherwise be supplied metadata generated by the first distributed computing component. The operating parameters and data generated in performing the same may be used as a feature set to train a machine learning model that is specific to the first distributed computing component. In other embodiments, a singular ML model may be used in which the feature set is based upon metadata and operating parameters of a plurality of distributed computing devices. The present disclosure contemplates that the first feature set may include any characteristic, attribute, data entry, or the like associated with the first distributed computing component without limitation.

Thereafter, as shown in operation 306, the system 130 may deploy the first trained ML model on the first component metadata. The first trained ML model may refer to a mathematical model generated by machine learning algorithms based on training data (e.g., the first feature set of the first distributed computing component), to make predictions or decisions without being explicitly programmed to do so. The first ML model represents what was learned by the selected machine learning algorithm and represents the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The first ML algorithm may refer to programs that are configured to self-adjust and perform better as they are exposed to more data. To this extent, the first ML algorithm is capable of adjusting its own parameters, based on previous performance in making prediction about a dataset.

As shown in operations 308, 310 the system 130 may, concurrently with or distinct from the operations above, generate a second feature set using the second component metadata and train the second trained ML model using the second feature set. By way of example, a second ML model may ingest or otherwise be supplied metadata generated by the second distributed computing component. The operating parameters and data generated in performing the same may be used as a feature set to train a machine learning model that is specific to the second distributed computing component. In other embodiments, a singular ML model may be used in which the feature set is based upon metadata and operating parameters of a plurality of distributed computing devices (e.g., the first and the second component metadata and operating parameters). The present disclosure contemplates that the second feature set may include any characteristic, attribute, data entry, or the like associated with the second distributed computing component without limitation.

Thereafter, as shown in operation 312, the system 130 may deploy the second trained ML model on the second component metadata. The second trained ML model may also refer to a mathematical model generated by machine learning algorithms based on training data (e.g., the first feature set of the first distributed computing component), to make predictions or decisions without being explicitly programmed to do so. The second ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The second ML algorithm may also refer to programs that are configured to self-adjust and perform better as they are exposed to more data. To this extent, the second ML algorithm is also capable of adjusting its own parameters, based on previous performance in making prediction about a dataset.

The ML algorithms contemplated, described, and/or used herein (e.g., the first and/or the second ML model(s)) include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized.

Thereafter, as shown in operation 314, the system 130 may determine the centralized governance dataset as described above with reference to FIG. 2. For example, the system may leverage the outputs of a trained ML model that is trained upon a combination of metadata from each or a plurality of distributed computing components or may leverage the outputs of component-specific machine learning models to generate the centralized governance dataset. As described above, the centralized governance dataset may operate as a singular representation of truth or valid data entries for the system 130. For example, in generating the centralized governance dataset, the system 130 may reconcile distinctions between the particular component formats used by the distributed computing components to form a centralized governance format that is standardized for access by the distributed computing components.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that may direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments may be configured without departing from the scope and spirit of the disclosure. Therefore, it is to be understood that, within the scope of the appended claims, the disclosure may be practiced other than as specifically described herein.

What is claimed is:

1. A system for centralized data governance within distributed component computing environments, the system comprising:
at least one non-transitory storage device; and
at least one processor coupled to the at least one non-transitory storage device, wherein the at least one processor is configured to:
receive, from a first distributed computing component, first component metadata associated with one or more operating parameters of the first distributed computing component;
receive, from a second distributed computing component, second component metadata associated with one or more operating parameters of the second distributed computing component;
determine, via a machine learning (ML) subsystem, a centralized governance dataset based upon the first component metadata and the second component metadata; and
generate a representation of the centralized governance dataset, wherein the representation is accessible by one or more of the first distributed computing component or the second distributed computing component.

2. The system of claim 1, wherein, in determining the centralized governance dataset, the processor is further configured to deploy, via the ML subsystem, a trained ML model on the first component metadata and the second component metadata.

3. The system of claim 2, wherein, prior to deployment of the trained ML model, the processor is further configured to:
generate a feature set using the first component metadata and the second component metadata; and
train, using the ML subsystem, the trained ML model using the feature set to generate the trained ML model.

4. The system of claim 1, wherein, in determining the centralized governance dataset, the processor is further configured to:
deploy, via the ML subsystem, a first trained ML model on the first component metadata; and
deploy, via the ML subsystem, a second trained ML model on the second component metadata.

5. The system of claim 4, wherein, prior to deployment of the first trained ML model, the processor is further configured to:
generate a first feature set using the first component metadata; and
train, using the ML subsystem, the first trained ML model using the first feature set to generate the first trained ML model.

6. The system of claim 4, wherein, prior to deployment of the second trained ML model, the processor is further configured to:
generate a second feature set using the second component metadata; and
train, using the ML subsystem, the second trained ML model using the second feature set to generate the second trained ML model.

7. The system of claim 1, wherein:
the first component metadata defines a first component format; and
the second component metadata defines a second component format.

8. The system of claim 7, wherein, in determining the centralized governance dataset, the processor is further configured to reconcile the first component format and the second component format to a centralized governance format.

9. The system of claim 1, wherein the processor is further configured to modify one or more of the first component format or the second component format responsive to the centralized governance dataset.

10. The system of claim 1, wherein the processor is further configured to modify one of more operations of the first distributed computing component and/or one or more operations the second distributed computing component responsive to the centralized governance dataset.

11. A computer program product for centralized data governance within distributed component computing environments, the computer program product comprising a non-transitory computer-readable medium comprising code causing an apparatus to:
receive, from a first distributed computing component, first component metadata associated with one or more operating parameters of the first distributed computing component;
receive, from a second distributed computing component, second component metadata associated with one or more operating parameters of the second distributed computing component;
determine, via a machine learning (ML) subsystem, a centralized governance dataset based upon the first component metadata and the second component metadata; and
generate a representation of the centralized governance dataset, wherein the representation is accessible by one or more of the first distributed computing component or the second distributed computing component.

12. The computer program product of claim 11, wherein, in determining the centralized governance dataset, the apparatus is further configured to deploy, via the ML subsystem, a trained ML model on the first component metadata and the second component metadata.

13. The computer program product of claim 11, wherein, in determining the centralized governance dataset, the apparatus is further configured to:
deploy, via the ML subsystem, a first trained ML model on the first component metadata; and
deploy, via the ML subsystem, a second trained ML model on the second component metadata.

14. The computer program product of claim 11, wherein the first component metadata defines a first component format, and the second component metadata defines a second component format, the apparatus further configured to reconcile the first component format and the second component format to a centralized governance format.

15. The computer program product of claim 11, wherein the apparatus is further configured to modify one or more of the first component format or the second component format responsive to the centralized governance dataset.

16. A method for centralized data governance within distributed component computing environments, the method comprising:
receiving, from a first distributed computing component, first component metadata associated with one or more operating parameters of the first distributed computing component;
receiving, from a second distributed computing component, second component metadata associated with one or more operating parameters of the second distributed computing component;
determining, via a machine learning (ML) subsystem, a centralized governance dataset based upon the first component metadata and the second component metadata; and
generating a representation of the centralized governance dataset, wherein the representation is accessible by one or more of the first distributed computing component or the second distributed computing component.

17. The method of claim 16, wherein, in determining the centralized governance dataset, the method further comprises deploying, via the ML subsystem, a trained ML model on the first component metadata and the second component metadata.

18. The method of claim 16, wherein, in determining the centralized governance dataset, the method further comprises:
deploying, via the ML subsystem, a first trained ML model on the first component metadata; and
deploying, via the ML subsystem, a second trained ML model on the second component metadata.

19. The method of claim 18, wherein the first component metadata defines a first component format, and the second component metadata defines a second component format, the method further comprising reconciling the first component format and the second component format to a centralized governance format.

20. The method of claim 16, further comprising modifying one or more of the first component format or the second component format responsive to the centralized governance dataset.
